(19) United States
(12) Patent Application Publication
(10) Pub. No.: US 2015/0060201 A1
(43) Pub. Date: Mar. 5, 2015

(54) Self Leveling Step Ladder with a Universal Hinge Joint

(71) Applicant: David J. Hume, Kailua-Kona, HI (US)

(72) Inventor: David J. Hume, Kailua-Kona, HI (US)

(21) Appl. No.: 14/477,835

(22) Filed: Sep. 4, 2014

Related U.S. Application Data
(60) Provisional application No. 61/959,848, filed on Sep. 4, 2013.

(51) Int. Cl. E06C 7/44; E06C 1/383

(52) U.S. Cl. CPC E06C 7/44; E06C 1/383
USPC 182/104

(57) ABSTRACT

A self leveling stepladder with a universal hinge joint providing many new advantages that traditional a-frame step ladders are not capable to deliver.

### Field Of Invention

The present invention relates to step ladders and more particularly pertains to an improvement to an A-frame ladder allowing it to be placed on uneven surfaces.

### BACKGROUND

Stepladders are free-standing ladders that can be erected without support from a wall, and can be folded together under transport. A stepladder consists of a step frame, which is pivotally attached to a smaller support frame. The step frame includes a number of rungs, or steps. Steps are climbing supports with “walking and/or stepping surfaces” typically ranging anywhere from 8 cm deep to 2-5 cm. The upper step is often a step-plate or platform, enabling a user to stand and move safely and comfortable. The step and support frames are connected by some locking mechanism that prevents the stepladder from collapsing.

### SUMMARY OF THE INVENTION

The present invention overcomes a limitation of the prior designs, specifically by providing an easy to use mechanism wherein the stepladder is self-leveling. Whilst similar to conventional stepladders in some respects, the instant invention is able to accommodate uneven ground by virtue of a unique hinge apparatus.

A conventional fold out type stepladder only works well on a flat surface and is very unstable on anything else. In such instances, all of the legs of the ladder fail to touch the surface. In such instances, the conventional stepladder is not stable and not easy to stand upon, when set on uneven ground. For example, a fruit picker's ladder solves part of the problem by only having three legs; two in a step frame and a single leg at the back. They work well when pushed between the branches and foliage of a tree, but are mostly unstable when free standing.

Many inventions have tried to address this problem but they are inadequate at best; most being of the extendable leg type. They are awkward and time consuming to set up, particularly when the ladder has to be moved to many locations as in fruit picking. In accordance with aspects of the present disclosure, the instant self leveling stepladder with a universal hinge joint provides many new advantages that traditional a-frame step ladders are not capable to deliver.

In the description herein, some details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

### BRIEF DESCRIPTION OF THE DRAWINGS

Embodiments of the present disclosure are described herein with reference to the drawings, in which:

FIG. 1 is a side front perspective drawing image of the self-leveling step ladder self-leveling on uneven ground, in accordance with an embodiment of the instant invention;

FIG. 2 is a side rear perspective drawing image of the self-leveling step ladder self-leveling on uneven ground, in accordance with an embodiment of the instant invention;

FIG. 3 is a front perspective drawing image of the self-leveling step ladder self-leveling on uneven ground, in accordance with an embodiment of the instant invention;

FIG. 4 is an exploded top perspective image of the hinge comprised of a rubber tendon joint as the universal hinge, in accordance with one embodiment of the instant invention;

FIG. 5 is an exploded top perspective image of the hinge comprised of a ball and socket joint as the universal hinge, in accordance with another embodiment of the instant invention;

FIG. 6 is an exploded top perspective image of the hinge comprised of a mechanical joint as the universal hinge, in accordance with another embodiment of the instant invention;

FIG. 7 is an exploded top perspective image of the hinge comprised of a set of interlocking eye joints serving as the universal hinge, in accordance with another embodiment of the instant invention; and

FIGS. 8A and 8B are side and top views of the hinge comprised of a rope threaded ball joint as the universal hinge, in accordance with another embodiment of the instant invention.

FIG. 9 is an alternate embodiment illustrating a Y-shaped frame side, in accordance with another embodiment of the invention.

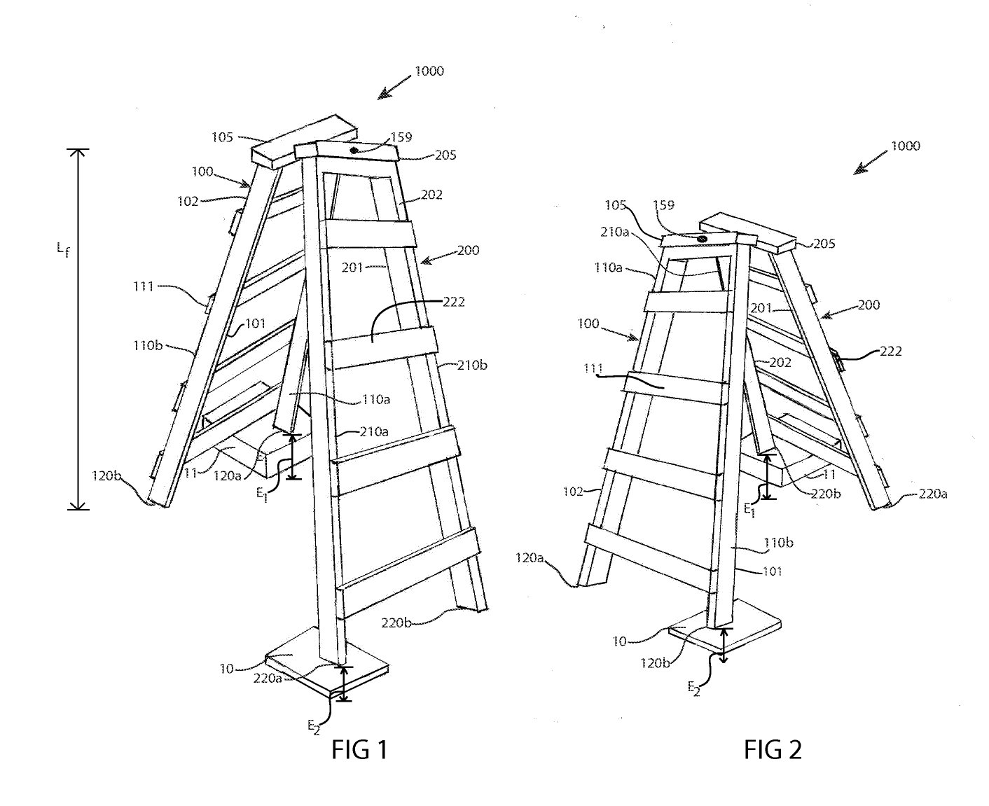

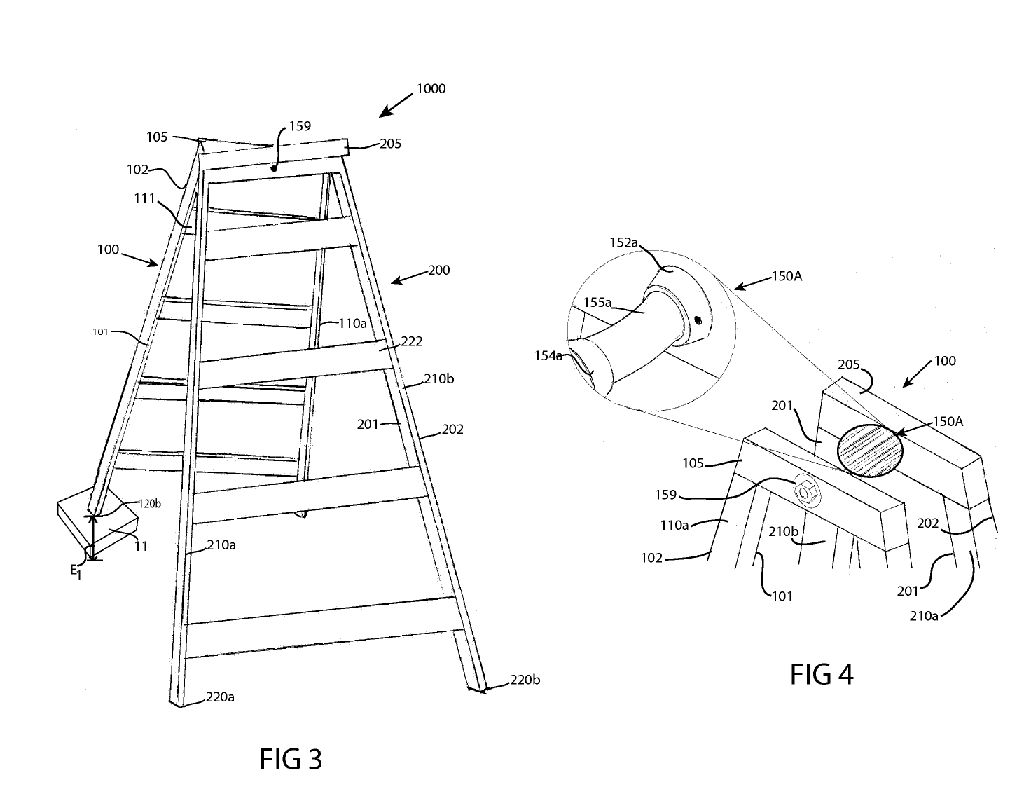

The novel features which are characteristic of the invention, as to organization and method of use, together with further objects and advantages thereof, may be better understood from the following brief disclosure considered in connection with the accompanying drawings in which one or more preferred embodiments of the invention are illustrated by way of example. It is to be expressly understood, however, that the drawings are for the purpose of illustration and description only and are not intended as a definition of the limits of the invention.

### DETAILED DESCRIPTION

The novelty of this invention revolves around the movement allowed by an unconventional hinge. Its unique design can be applied to almost any type of fold out step ladder. By virtue of the hinge, the two sides of a fold-out step ladder are allowed full movement in all planes. The two sides can open conventionally and also swing from side to side and at angles to each other. Their movement allows all four legs of the ladder to find contact with uneven ground and provide a stable platform to climb up on.

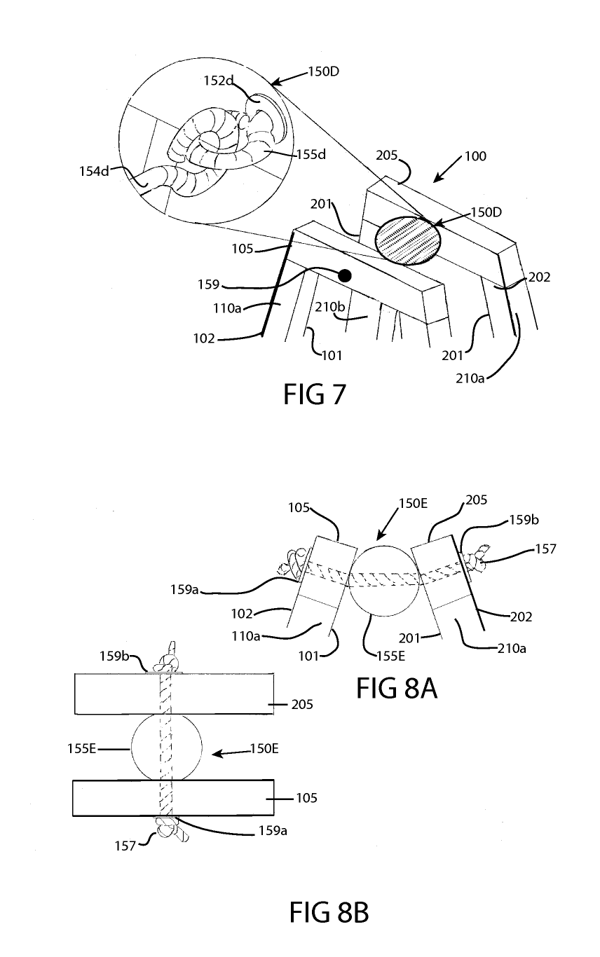

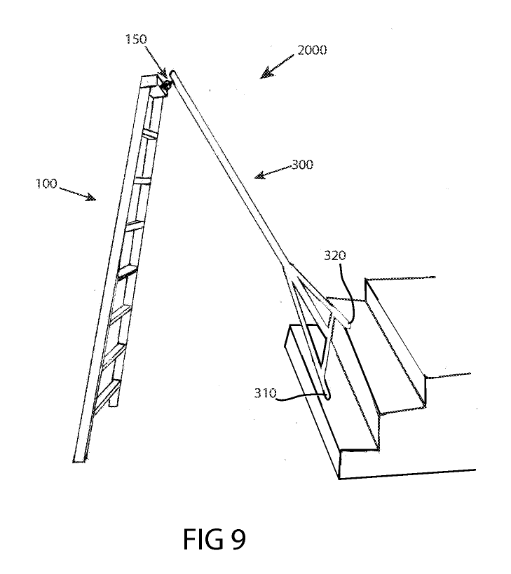

The universal hinge may be many possible versions, as illustrated in FIGS. 4-8. For example, the universal joint may comprise an embodiments as simple as two linked eyes (FIG. 7), one on each step frame, a piece of rope or cable passing through each frame. Or, alternatively, in another embodiment, a more complex version such as a knuckle style joint (FIG. 5), similar to that used in automobile suspension. Whatever way, free movement to both frames will allow for all four legs to be stable on uneven ground.

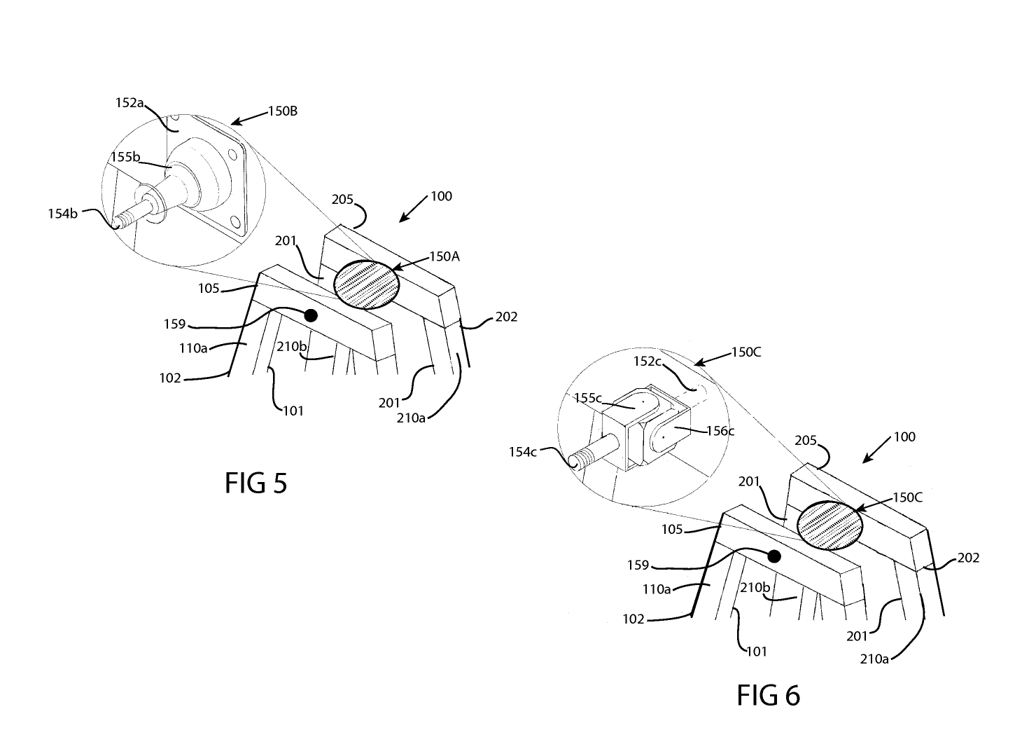

Although this is a novel universal joint, there is nothing highly technological about the hinge. It could be merely two eye bolts linked together or two U-bolts; one attached to either frame. It could be as simple as a cable or tendon (FIG. 6) from one side to the other. This design allows the ladder to open conventionally and also allows the frames to move from side to side independent of each other. It is this free movement in all planes that allows for all four legs to contact the uneven ground at the same time. The ladder very easily and quickly finds a stable position for safe climbing.

The applications and usage are many for the instant invention, ranging from a two or three step utility ladder, to high reaching ladders suitable for fruit picking. The invention will suit any application using a four-legged adjustable ladder on uneven ground. This style of four legged fruit picker ladder is much more stable than the three legged version. All versions allow movement in three planes to allow four-leg contact and engagement with uneven ground. It is to be appreciated that one or more of the elements depicted in the drawings/figures can also be implemented in a more separated or integrated manner, or even removed or rendered as inoperable in certain cases, as is useful in accordance with a particular application. Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth.

For example, the ladder having a wider base going up to a more triangular point—picker style—could be made of aluminum and fiberglass sides and round ladder rungs. Various sizes will accommodate all sorts of picking from straddling berries to picking coffee, for example, on mountain sides and all kinds or other fruits up to 16 feet or more. In other examples, configuring the instant invention as a low level two or three step ladder—non wobbly—for garden use, clipping and pruning.

Therefore, many modifications may be made to adapt a particular situation or material to the essential scope and spirit of the present invention. It is intended that the invention not be limited to the particular terms used and/or to the particular embodiment disclosed as the best mode contemplated for carrying out this invention, but that the invention will include any and all embodiments and equivalents falling within the scope of the instant disclosure.

The foregoing description of illustrated embodiments of the present invention, including what is described herein, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

I claim:

1. A self-leveling ladder apparatus comprising:
a first ladder frame,
a second ladder frame, and
a universal hinge joint coupled to said first ladder frame and said second ladder frame, said universal hinge joint providing relative motion between the two frames.
